(19) United States
(12) Patent Application Publication
(10) Pub. No.: US 2015/0218004 A1
(43) Pub. Date: Aug. 6, 2015

(54) SILICON CARBIDE POWDER, AND PREPARATION METHOD THEREFOR

(71) Applicants: LG INOTEK CO., LTD., Seoul (KR); RESEARCH BUSINESS FOUNDATION SUNGKYUNKWAN UNIVERSITY, Suwon-si, Gyeonggi-do (KR)

(72) Inventors: Jung Eun Han, Seoul (KR); Dong Geun Shin, Seoul (KR); Byung Sook Kim, Seoul (KR); Kyoung Seok Min, Seoul (KR)

(73) Assignee: LG INNOTEK CO., LTD., Seoul (KR)

(21) Appl. No.: 14/408,071

(22) PCT Filed: Jul. 10, 2013
(86) PCT No.: PCT/KR2013/006164

§ 371 Date: Dec. 15, 2014

(30) Foreign Application Priority Data
Oct. 18, 2012 (KR) 10-2012-0115737

(51) Int. Cl. C01B 31/36; C04B 35/573

(52) U.S. Cl. CPC C01B 31/36; C04B 35/573; C01P 2004/54; C01P 2006/80; C04B 2235/383; C04B 2235/5427; C04B 2235/5463

(57) ABSTRACT

A method for preparing a silicon carbide power includes collecting a mixture powder by mixing a carbon source and a silicon source, synthesizing a first silicon carbide powder by heating the mixture powder, forming an agglomerated powder by agglomerating the first silicon carbide powder, and forming a second silicon carbide powder, which has larger particles than the first silicon carbide powder, by heating the agglomerated powder.

### TECHNICAL FIELD

The invention relates to a silicon carbide powder and a method of preparing the same, and more particularly, to a method of preparing a granular silicon carbide powder using a particulate silicon carbide powder.

### BACKGROUND ART

Silicon carbide (SiC) has a high-temperature strength and excellent wear-resistance, oxidation-resistance, corrosion-resistance, creep-resistance, and the like. Silicon carbide is, divided into a β-phase having a cubic crystalline structure and an α-phase having a hexagonal crystalline structure. The β-phase is stable at a temperature in a range of 1,400 to 1,800° C. and the a-phase is formed at 2,000° C. or more.

Silicon carbide has been widely used as a material for an industrial structure, and has been used in the semiconductor industry recently. In order to utilize silicon carbide for single crystal growth, a granular silicon carbide powder having a uniform particle-size distribution is required.

For example, the silicon carbide powder is prepared by an Acheson method, a carbothermal reduction method, a chemical vapor deposition (CVD) process, etc. A separate high purity process is needed for the silicon carbide powder prepared by one of the above methods due to a low purity, and an additional grinding process is needed.

A granular silicon carbide powder having a high purity may be obtained by performing high-temperature heat treatment on a refined particulate silicon carbide powder at 2,000° C. or more, but there is a problem in which a particle-size distribution is non-uniform.

### DISCLOSURE

### Technical Problem

The present invention provides a granular silicon carbide powder which has a high purity and a uniform particle-size distribution, and a method of preparing the same.

### Technical Solution

One aspect of the present invention provides a method of preparing a silicon carbide powder, the method including: collecting a mixed powder by mixing a carbon source and a silicon source; synthesizing a first silicon carbide powder by heating the mixed powder; forming an agglomerated powder by agglomerating the first silicon carbide powder; and forming a second silicon carbide powder, which has a particle size greater than the first silicon carbide powder, by heating the agglomerated powder.

The first silicon carbide powder may have a β-phase, and the second silicon carbide powder may have an a-phase.

The agglomerated powder may be formed using water or a volatile organic solvent.

The agglomerated powder may be formed in a chamber in which an impeller is installed, by mixing the first silicon carbide powder with water or a volatile organic solvent.

The synthesizing of the first silicon carbide powder may include a carbonization process performed at a temperature in a range of 600° C. to 1,000° C., and a synthesis process performed at a temperature in a range of 1,300° C. to 1,700° C.

The forming of the second silicon carbide powder may be performed at a temperature in a range of 2,000° C. to 2,200° C.

Another aspect of the present invention silicon provides a carbide powder, the powder including: a granular silicon carbide powder having an α-phase, wherein a particle-size distribution thereof ranges from 100 μm to 10 mm, a distribution (D90/D10) thereof ranges from 1 to 10, nitrogen is included at 500 ppm or less, and oxygen is included at 1,000 ppm or less.

The granular silicon carbide powder having the a-phase may have the particle-size distribution in a range of 100 μm to 5 mm, the distribution (D90/D 10) in a range of 1 to 5, and oxygen in a range of 500 ppm or less.

The granular silicon carbide powder having the a-phase may have the particle-size distribution in a range of 100 μm to l mm, the distribution (D9O/D10) in a range of 1 to 3, and oxygen in a range of 500 ppm or less.

### Advantageous Effects

According to the embodiment of the present invention, a silicon carbide powder, which has a high purity and a uniform particle-size distribution, can be obtained. Further, since the silicon carbide powder having the uniform particle-size distribution can be used in single crystal growth, control of a temperature and sublimation is easy during the single crystal growth, and a single crystal having a high quality can be obtained.

### DESCRIPTION OF DRAWINGS

FIG. 1 is a flowchart illustrating a method of preparing a silicon carbide according to an embodiment of the present invention.

FIG. 2 is a view of a granular silicon carbide powder prepared according to a comparative example.

FIG. 3 is a view of a granular silicon carbide powder prepared according to the embodiment of the present invention.

### MODES OF THE INVENTION

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention.

It will be understood that, although the terms “first,” “second,” etc. may be used herein to describe various components, these components should not be limited by these terms. These terms are only used to distinguish one component from another component. Thus, a first component discussed below could be termed a second component and the second component discussed below could be termed the first component without departing from the teachings of the present inventive concept. The term “and/or” includes any and all combinations of one or more referents.

The terminology used herein is for the purpose of describing particular embodiments only and is not intended to be limiting of the present inventive concept. As used herein, the singular forms “a,” “an,” and “the,” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of, the relevant art and will not be interpreted in an idealized or overly formal sense unless expressly so defined herein.

Hereinafter, embodiments of the present invention will now be described more fully with reference to the accompanying drawings. In this specification, it should be noted that, although the same or corresponding components are illustrated in different drawings, the same numerals are assigned as much as possible and repeated descriptions thereof will be omitted.

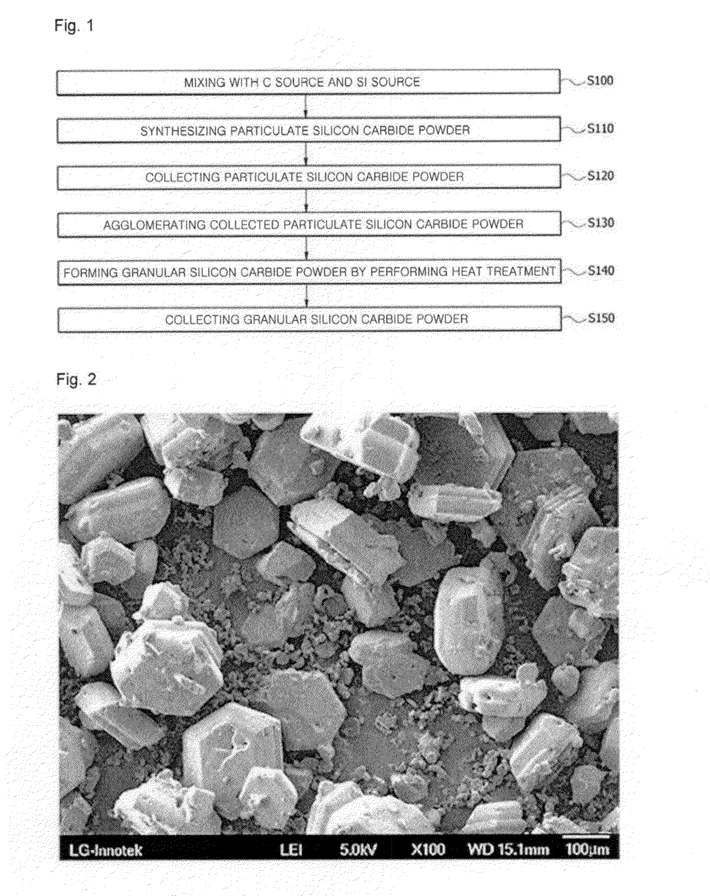

FIG. 1, is a flowchart illustrating a method of preparing a silicon carbide according to an embodiment of the present invention.

Referring to FIG. 1, firstly, a Si source and a C source are mixed (S100). Here, mole fractions of silicon included in the Si source and carbon included in the C source may be in a range of 1:1.5 to 1:3. For example, the mole fractions of silicon included in the Si source and carbon included in the C source may be 1:2.5.

The Si source denotes a material which provides silicon. For example, the Si source may be one or more selected from the group of fumed silica, a silica sol, a silica gel, particulate silica, a quartz powder, and a mixture thereof.

The C source may be a solid C source or an organic carbon compound. For example, the solid C source may be one or more selected from the group of graphite, carbon black, a carbon nanotube (CNT), a fullerene, and a mixture thereof. The organic carbon compound may be one or more selected from the group of a phenol resin, a franc resin, a xylene resin, a polyimide, polyurethane, polyvinyl alcohol, polyacrylonitrile, polyvinyl acetate, cellulose, and a mixture thereof.

The Si source and the C source may be mixed by a precipitate or fumed process. For example, the Si source and the C source may be mixed using a super mixer, a ball mill, a attrition mill, a 3-roll mill, etc.

Next, a particulate silicon carbide powder is synthesized by heating the mixed powder (S110). The heating of the mixed powder is divided into a carbonization process and synthesis process. For example, the carbonization process may be performed at a temperature in a range of 600° C. to 1,000° C., and the synthesis process may be performed at a temperature in a range of 1,300° C. to 1,700° C. for a predetermined time (e.g., 3 hours), but these are not limited thereto.

The particulate silicon carbide powder formed by the above process may have a n-phase and a non-uniform particle-size distribution. The particle mean diameter of the particulate silicon carbide powder may be in a range of 1 μm to 5 μm.

Next, the particulate silicon carbide powder is collected (S120) and agglomerated (S130). The process of agglomerating the particulate silicon carbide powder may be performed in a chamber in which an impeller is installed. For example, the impeller may be a paddle type, a propeller type, a screw type, a turbine type, etc.

To this end, after filling the particulate silicon carbide powder in a chamber, water or a volatile organic solvent (e.g., alcohol) may be sprayed while rotating the impeller. Thus, an agglomerated powder in which the particulate silicon carbide powder is agglomerated may be formed. The agglomerated powder may have a uniform particle size in a range of 20 μm to 80 μm.

Then, a granular silicon carbide powder is formed (S140) by performing high-temperature heat treatment on the agglomerated powder, and the granular silicon carbide powder is collected (S150). Here, the high-temperature heat treatment may be performed in a sealed crucible furnace or a crucible furnace charged by an inert gas (e.g., Ar) at a temperature in a range of 2,000° C. to 2,200° C.

The granular silicon carbide powder formed by the above process may have an a-phase. A particle size (D50) of the granular silicon carbide powder prepared by the method according to the embodiment of the present invention ranges from 100 μm to 10 mm, preferably from 100 μm to 5 mm, and more preferably from 100 μm to 1 mm. Further, a distribution (D90/D10) of the granular silicon carbide powder prepared by the method according to the embodiment of the present invention ranges from 1 to 10, preferably 1 to 5, and more preferably 1 to 3. Furthermore, purity of the granular silicon carbide powder prepared by the method according to the embodiment of the present invention has nitrogen (N) in a range of 500 ppm or less and oxygen (O) in a range of 500 ppm or less. Here, the term “D50” denotes a particle size of a powder corresponding to the bottom 50%, the term “D10” denotes a particle size of a powder corresponding to the bottom 10%, and the term “D90” denotes a particle size of a powder corresponding to the bottom 90%.

As described above, when the particulate silicon carbide powder is agglomerated, the agglomerated powder having a uniform particle size may be obtained. In addition, since the agglomerated powder may be easily combined with surrounding agglomerated powders in the process of high-temperature heat treatment, the granular silicon carbide powder having a uniform particle-size distribution may be obtained.

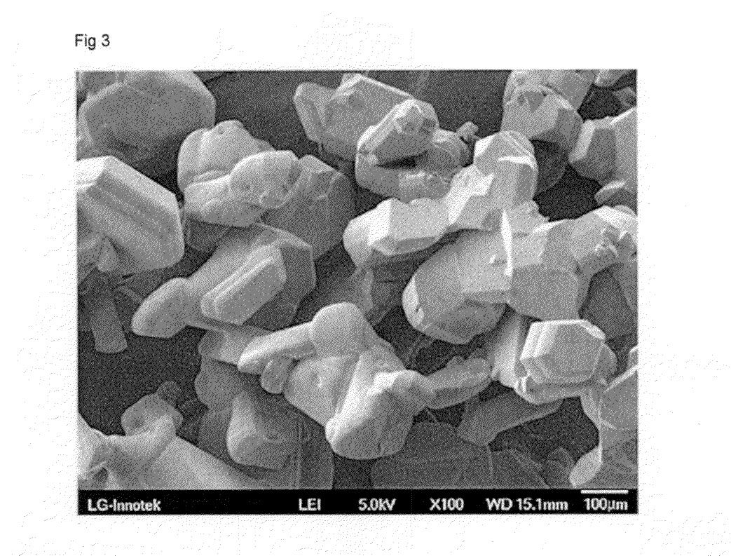

FIG. 2 is a view of a granular silicon carbide powder prepared according to a comparative example, and FIG. 3 is a view of a granular silicon carbide powder prepared according to the embodiment of the present invention. Referring to FIG. 2, a particulate silicon carbide powder was synthesized, after carbonizing a mixed powder, which was mixed with fumed silica serving as a Si source and a phenol resin serving as a C source, at 850° C. and maintaining the powder for 3 hours at 1,700° C. A non-uniform granular silicon carbide powder was obtained by maintaining a particulate silicon carbide powder having a particle mean diameter in a range of 1 μm to 5 μm for 6 hours at 2,100° C. in a crucible furnace charged by an inert gas.

Referring to FIG. 3, a particulate silicon carbide powder was synthesized, after carbonizing a mixed powder, which was mixed with fumed silica serving as a Si source and phenol resin serving as a C source, at 850° C. and maintaining the powder for 3 hours at 1,700° C. The particulate silicon carbide powder having a particle mean diameter in a range of 1 μm to 5 μm was placed in a chamber in which an impeller was installed, and a small amount of alcohol was sprayed and mixed therewith, and thus an agglomerated powder having a particle size in a range of 20 μm to 80 μm was formed. A uniform granular silicon carbide powder was obtained by maintaining the agglomerated powder for 6 hours at 2,100° C. in a crucible furnace charged by an inert gas.

As described in FIGS. 2 and 3, the granular silicon carbide powder having a uniform particle-size distribution may be obtained when an additional agglomerate process is performed before high-temperature heat treatment is performed on the particulate silicon carbide powder.

As described above, a distribution (D90/D10) of the granular silicon carbide powder prepared by the method according to the embodiment of the present invention, this is, a ratio of D10 to D90, is in a range of 1 to 3. Thus, it showed that the granular silicon carbide powder having a uniform particle-size distribution may be obtained.

When sublimating a single crystal using a silicon carbide powder having a non-uniform particle-size distribution, that is, a large distribution, pores having non-uniform sizes are generated, a temperature grade of the silicon carbide powder is changed, and control of an amount of sublimation and a speed of sublimation is difficult. Otherwise, when sublimating a single crystal using a silicon carbide powder having a uniform particle-size distribution, that is, a small distribution, the control of the temperature grade of the silicon carbide powder is easy due to pores having a uniform size, and the control of the amount of sublimation and the speed of sublimation is easy. Accordingly, a single crystal having a high quality may be obtained when using the silicon carbide powder obtained according to the embodiment of the present invention.

Although a few embodiments have been described, those skilled in the art will readily appreciate that many modifications are possible in embodiments without materially departing from the novel teachings and advantages. Accordingly, all such modifications are intended to be included within the scope of this inventive concept as defined in the claims.

1. A silicon carbide powder comprising:
a granular silicon carbide powder having an alpha phase, wherein a particle size (D50) thereof ranges from 100 μm to 10 mm, a distribution (D90/D10) thereof ranges from 1 to 10, nitrogen is included at 500 ppm or less, and oxygen is included at 1,000 ppm or less.

2. The silicon carbide powder of claim 1, wherein the granular silicon carbide powder having the alpha phase has the particle size (D50) in a range of 100 μm to 5 mm, the distribution (D90/D 10) in a range of 1 to 5, and the oxygen in a range of 500 ppm or less.

3. The silicon carbide powder of claim 2, wherein the granular silicon carbide powder having the alpha phase has the particle size (D50) in a range of 100 μm to 1 mm, the distribution (D90/D10) in a range of 1 to 3, and the oxygen in a range of 500 ppm or less.
